(19) United States
(12) Patent Application Publication
(10) Pub. No.: US 2002/0065716 A1
(43) Pub. Date: May 30, 2002

(54) Methods and system for processing loyalty transactions

(76) Inventor: James E. Kuschill, Newtown, OH (US)

Correspondence Address: DINSMORE & SHOHL, LLP, 1900 CHEMED CENTER, 255 EAST FIFTH STREET, CINCINNATI, OH, 45202, US

(21) Appl. No.: 09/728,597

(22) Filed: Nov. 30, 2000

(51) Int. Cl. G06F 17/60

(52) U.S. Cl. 705/14

(57) ABSTRACT

Methods and a system are provided to receive loyalty transactions over disparate channels in different data formats. The different data formats are translated to a processing format and processed. Moreover, a single loyalty transaction is translated from a first format to a second format for processing, and after processing a response is translated to the first format and sent in response to the initial loyalty transaction. Further, a first loyalty transaction in a first format occurring over a first channel is provided along with a second loyalty transaction in a second format occurring over a second channel. An interfacing set of executable instructions translates the first and second formats to a processing format. Finally, a processing set of executable instructions processes the first and second loyalty transactions in the processing format.

### FIELD OF THE INVENTION

The present invention relates to methods and a systems for capturing and processing transactions associated with loyalty based incentive programs.

### BACKGROUND OF THE INVENTION

In an effort to increase customer demand for goods and services provided by merchants, loyalty programs are often developed by the merchants whereby customers receive loyalty points or rewards for participating in the programs based on rules associated with the programs. By way of example, consider a popular type of loyalty program which rewards air travelers with mileage credits or loyalty points for miles flown on a specified airline. Once an air traveler reaches a predetermined mileage total, the credits may be redeemed by the air traveler for free air travel. Many additional rules are associated with such frequent flyer loyalty programs. Moreover, air travelers also may receive mileage credit for purchasing certain goods or services, or for using a specified credit card for a customer transaction.

Loyalty programs are typically implemented in software applications that electronically define the loyalty transactions which are considered to be within the confines of the program's scope, and when these transactions are detected an electronic trigger will cause some action on the part of the loyalty programs to occur. For example, a first merchant having a loyalty program, may develop a partnership with a second merchant whereby a customer of the first merchant is credited with loyalty points which may be used to for purchase goods or services of the second merchant.

There are a variety of problems which merchants may encounter when trying to implement successful loyalty programs. First, separate accounts for loyalty customers will need to be electronically established along with the means for recording a variety of data which will be necessary for successfully managing the loyalty program. For example, loyalty customer contact information, loyalty point totals, loyalty expiration dates, loyalty transaction summaries, and the like.

Second it is not cost effective for merchants to undergo the substantial software development and maintenance expenses associated with the electronic implementations of loyalty programs. Accordingly, merchants will in large part seek third-party service providers or third-party software packages which are equipped to electronically track, report, and manage the merchant's loyalty program. Some of these service providers or software packages permit a merchant to electronically define the rules of the loyalty program and to track the loyalty program electronically.

Further, some merchants have internally-developed legacy software systems which are already being used to manage loyalty programs. Often, these legacy systems are not capable of communicating in any effective way with more recent technology, such as, for example, the Internet. These merchants using legacy systems are often faced with the monumental task of attempting to port their existing systems to new environments, or to rewrite the legacy systems from scratch. In most cases, neither option is cost effective, and these merchants will turn to third parties to assist in implementing new loyalty programs and in adapting their existing legacy loyalty programs to new technologies.

Compounding the problems for merchants is the increasing mobility of loyalty customers, and the increasing desire of these customers to transact with merchants via a variety of channels. Channels include the communication protocols associated with a data transaction. These protocols may occur over a variety of devices and media. For example, and by way of example only, customers may transact with a vendor via any of the following channels: wireless channels, traditional phone channels, point of sale channels, kiosk channels, Internet channels, web television channels, interactive television channels, automated teller machines (ATM), a variety of computing device channels (e.g. personal digital assistants, digital phones, digital cable boxes, computers, intelligent appliances, and the like), traditional brick and mortar channels, file transfer protocol channels, and others.

Historically, merchants have been forced to develop methods and systems for capturing loyalty transactions occurring over each channel separately. In fact, it is not uncommon for merchants to have stand alone software legacy methods and systems for each specific channel, such as one system for point-of-sale transactions and another system for the Internet. These stand alone systems do not effectively communicate with one anther, and often a single loyalty customer will have multiple accounts with a merchant wherein each account is associated with one of these stand alone systems.

Furthermore, as customers transact over a variety of disparate channels the devices used with each of these channels will require that information which is to be displayed on the devices must be in a specific data format, for purposes of compatibly displaying the information on the device. More often than not, the data formats required by each of these devices to display information electronically will not comport with the information data format of the merchant's legacy or third-party acquired systems, thereby requiring individual data format conversions or translations in order for the merchant's system to communicate with these customer chosen devices.

Recently as a result of an industry consortium, data format standards have been developed in an attempt to alleviate the communication problems associated with incompatible data formats occurring between disparate devices and channels during an electronic transaction. Presently, the globally accepted data format standard which has emerged is Extensible Markup Language (XML) data format. XML divorces the data presentation attributes typically associated with data from the actual data content attributes. In this way, aspects typically associated only with how a device presents the data are removed from aspects which define the data content. In this manner, data transmission becomes device independent, and the presentation of the data on a particular device becomes the responsibility of the displaying device.

The data presentation attributes contained within the data are often the root of problems associated with data format incompatibility. For example, an Hyper Text Markup Language (HTML) “<bold>” tag embedded in a data stream would indicate that the string which follows the tag is to be presented in bold, but some software and some devices may not be capable of performing a bold operation and may instead underline the string attribute or, worst yet, not display the string at all. The inability to recognize or uniformly handle data presentation tags renders most data transactions useless, since data streams are riddled with presentation attributes (e.g. HTML, Portable Document Format (PDF), and others).

In contrast, data content tags describe the structure and content of the data stream itself, and the ability to recognize these types of tags actually assist disparate software and devices in parsing, displaying, and using the data in a compatible fashion. Essentially, within the XML data format paradigm, data presentation is left to the individual devices and the software systems associated with the individual devices, and the data providers agree to define data content in a uniform manner in order to promote more seamless data transactions.

XML by itself is not particularly useful since it still must be rendered into a presentation format. Correspondingly, a variety of off-the-shelf software parsing and data languages are available to render XML into a variety of presentation formats. By way of example only, consider the parsing and data language of Extended Stylesheets Language Transformations (XSLT) which permits easy manipulation of XML documents to create a wide variety of customizable layout styles and data presentations. XSLT may be used to take a data stream defined by XML and render that data stream displayable in an Internet web browser in HTML format. Moreover, XML documents themselves may be defined by a very small mathematical lexicon defined in a small document, often called a Document Type Definition (DTD). DTD's may be used as input to parsers to validate and assist in parsing the data content associated with an XML document. These techniques and software applications are well known to those skilled in the art.

Further, a variety of data viewers, which are used on a multitude of disparate devices, have developed translators to render XML encoded data streams into a compatible data format with the viewers. In this way, data communications between disparate devices, utilizing disparate channels, have started to be more seamless and integrated. Yet, loyalty programs have largely not participated in the recent XML revolution, since it remains cost prohibitive and extremely resource intensive for existing loyalty systems to be made compatible with XML encoded data streams.

As such, there remains a need for methods and systems for customers to more freely transact with loyalty programs and for merchants to more efficiently manage and record such transactions.

### SUMMARY OF THE INVENTION

Accordingly, it is an object of the present invention to provide novel methods and systems for tracking loyalty transactions over disparate channels. Moreover, methods of processing loyalty transactions and a system for processing loyalty transactions over disparate channels are provided. These and additional objects and advantages will become apparent.

Loyalty customers interact with a loyalty program over a variety of channels using a variety of devices. These interactions are loyalty transactions which are translated from a specific channel data format to a loyalty program recognized data format for processing. After processing the transactions, any responses generated by the loyalty program are translated to an appropriate channel data format and sent to the loyalty customer. In this way a loyalty customer may transact over disparate channels with a loyalty program. Moreover, a single loyalty customer may simultaneously transact over disparate channels with the loyalty program.

One aspect of the present invention is a method for tracking loyalty transactions over disparate channels. The method comprises receiving a first loyalty transaction in a first format over a first channel and receiving a second loyalty transaction in a second format over a second channel. The first and second loyalty transactions are translated to a third format for processing.

Further, a method of processing a loyalty transaction is provided, comprising translating a loyalty transaction from a first format to a second format and processing the loyalty transaction in the second format. A response is then generated and sent after being translated to the first format.

Moreover, a system for processing loyalty transactions over disparate channels is provided, comprising an interface set of executable instructions operable to translate a first loyalty transaction having a first format and occurring over a first channel to a processing format. The interface set of executable instructions is also operable to translate a second loyalty transaction having a second format and occurring over a second channel to the processing format. Furthermore, a processing set of executable instructions processes the first and second loyalty transactions in the processing format.

Still other aspects of the present invention will become apparent to those skilled in the art from the following description of exemplary embodiments, which is, by way of illustration, one of the best modes contemplated for carrying out the invention. As will be realized, the invention is capable of other different and obvious implementations, all without departing from the scope of the present invention. Accordingly, the drawings and descriptions are illustrative in nature only and are not restrictive.

### BRIEF DESCRIPTION OF THE DRAWINGS

The accompanying drawings, incorporated in and forming part of the specification, illustrate several aspects of the present invention and, together with their descriptions, serve to explain the principles of the invention. In the drawings:

FIG. 1 depicts a flow diagram of a method for tracking loyalty transactions;

FIG. 2 depicts a flow diagram of a method for processing a loyalty transaction;

FIG. 3 depicts a block diagram of a system for processing loyalty transactions; and

FIG. 4 depicts a schematic diagram of an architecture for processing loyalty transactions.

### DETAILED DESCRIPTION

The present invention provides methods and a systems which permit customers to interact with loyalty programs using multiple disparate channels. As previously presented, channels include the communication protocols used by a variety of devices while communicating over a variety of media. Further, the loyalty programs are embodied in software applications referred to as loyalty program applications. Electronic transactions are translated or rendered from a first format into a format which is useable by a loyalty program application. The transaction is processed by the loyalty program application and any response to the transactions is translated back into the first format for delivery to the devices.

One embodiment of the present invention is implemented using web browser technologies using any of a variety of well-known software programming languages (e.g., C, C++, Java, JavaBeans, ActiveX, Active Server Pages) and Internet communication protocols (TCP/IP). Moreover, data formatting languages are used such as XML, HTML, and XSLT may be used. Of course other programming languages, communications protocols, and data formatting languages (now known or hereafter developed) may be also readily employed without departing from the scope of the present invention.

Further, loyalty program applications may be implemented with any of the above mentioned technologies. These applications are developed to run on computing devices and need not be centralized on any single computing device, but may be dispersed out over an entire computing network. Loyalty program applications are well known to those skilled in the art, and may be purchased directly by merchants. Moreover, loyalty program applications may be developed on an ad hoc basis depending upon the individualized needs of a merchant.

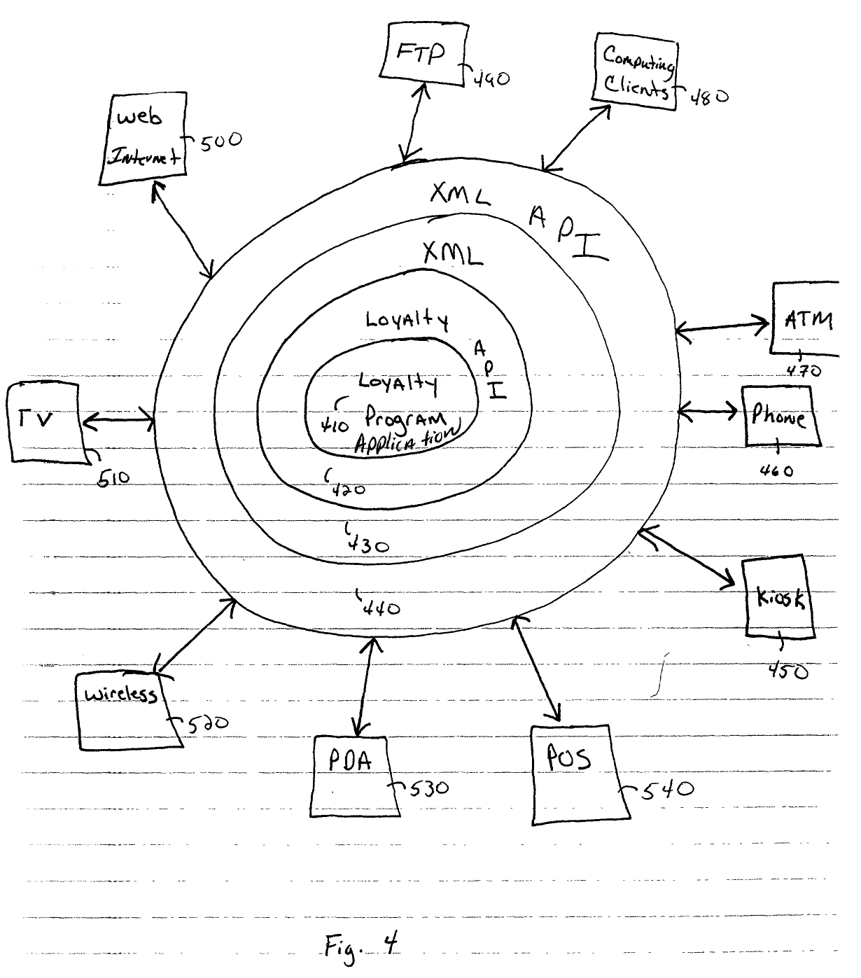

FIG. 4 illustrates a schematic diagram of an architecture for processing loyalty transactions. By way of example only, consider a web browser which is used to display data and receive and transmit data across the Internet. Web browsers have been developed and are commercially available for a variety of computing devices, such as by way of example only, file transfer protocol (FTP) clients 490, computing clients 480, automated teller machines (ATM) 470, telephones 460 (using, for example, recent voice to text and text to voice technology such as TellMe®), kiosks 450, point of sale clients (POS) such as credit card reading devices 540, personal digital assistants (PDA) 530, wireless clients 520, televisions 510, web televisions 500, and others. However, as one skilled in the art will readily appreciate a variety of non-standard viewers are typically used by the devices of FIG. 4, without the need for standard viewers provided in the industry.

As used herein, the term loyalty program is intended to refer to rules developed by a merchant which are used to encourage participants to acquire incentive points, credits, miles, dollars, or any other incentive currency. These programs are often used for marketing purposes by the merchants and are well known to those skilled in the art.

In the system of FIG. 4, a loyalty program is embodied and implemented as one or more software modules (e.g. loyalty program application 410), whereby participants may acquire incentive points based on transactions which the loyalty program application 410 is designed to recognize, such as and by way of example only, purchases made by a participant using a credit card wherein the dollar amount of a purchase made by the participant results in a corresponding incentive award total associated with the loyalty program which was designed by a merchant and embodied as the loyalty program application 410.

The loyalty program application 410 communicates with an application programming interface (API) 420, which permits external communication with the loyalty program application 410. API's are well known to those skilled in the art, and are a way in which an interface to the internal operations of a proprietary software application may be provided to externally calling software applications in a uniform and consistent way. Further, API's allow external software applications to customize calls which are made to the internal software application.

The loyalty API 420 may be configured such that data sent from the API 420, after receiving response data from the loyalty program application 410, is in a consistent format, such as by way of example only, XML and further, the data received from the API, after receiving a loyalty transaction, is in XML. Received data, in XML format, may then be rendered using, by way of example only, XSLT which translates the raw XML into a format needed by the loyalty program application 410 for processing. In this way, the API 420 is operable to receive and deliver raw XML 430.

Moreover, an XML API 440 may be provided by each device enumerated in FIG. 4, this XML API 440 comprises an XSLT rendering application or any other XML rendering application technology which is operable to present XML on the devices and receive XML from the devices. In this way, simple and less complex XSLT application data files may be written for each device in FIG. 4, such that the device may display and interact with raw XML 430 data that corresponds to data required by the loyalty program application 410. Furthermore, it may be that the loyalty API 420 detects which device is attempting to initiate a transaction with the loyalty program application 410 and correspondingly selects a pre-defined XSLT data file for the initiating device to use during the transaction.

By way of example only, consider a transaction occurring from a device, such as a web-based or other Internet enabled client 500, wherein a request is made to retrieve a customer's loyalty information. The raw XML 430 associated with such a request may be encoded as follows: “<GMI>SSN</GMI>”, where “<GMI>” is a begin XML 430 tag indicating that a get-member-information data request is being made; the “SSN” is the social security number or other identification number of the member requesting the information; and the “</GMI>” is the end XML 430 tag indicating the information required by the get-member-information data request is completed.

Such an encoded data stream would be received by the loyalty API 420 and associated with an XSLT data rendering application, where the data following the “<GMI>” tag (e.g. “SSN”) is associated with a series of proprietary commands made to the loyalty program 420 data store, such as by way of example only, “return name, balance, address where KEY=SSN” where a data store row is requested for a KEY having the “SSN” value, and the variables which are sought are “name,” “balance,” and “address.” Once these variable values are returned, the loyalty API 420 will render these data to a raw XML 430 using again an XSLT data rendering application. The raw XML 430 is then used by the XML API 440 of the web client 500 and displayed to the customer via a web browser in a format recognizable by the customer (e.g. a HTML web page).

The web client 500 need not have possession, or be given possession of the XSLT data rendering application until the web client 500 needs the application to render the raw XML 430. Further, the web client 500 may not ever have possession of the XSLT data rendering application, rather, this application may be a service provided from a remote computing device, such as a web server.

As one skilled in the art will readily appreciate, this technique permits two disparate applications, namely a web browser application and a proprietary loyalty program, to seamlessly interact with one another using standard data formatting technologies. Further, with the widespread adoption of XML data formatting standards, a variety of devices utilizing a multitude of communication channels may use the techniques of the present invention to seamlessly interact with legacy based loyalty programs.

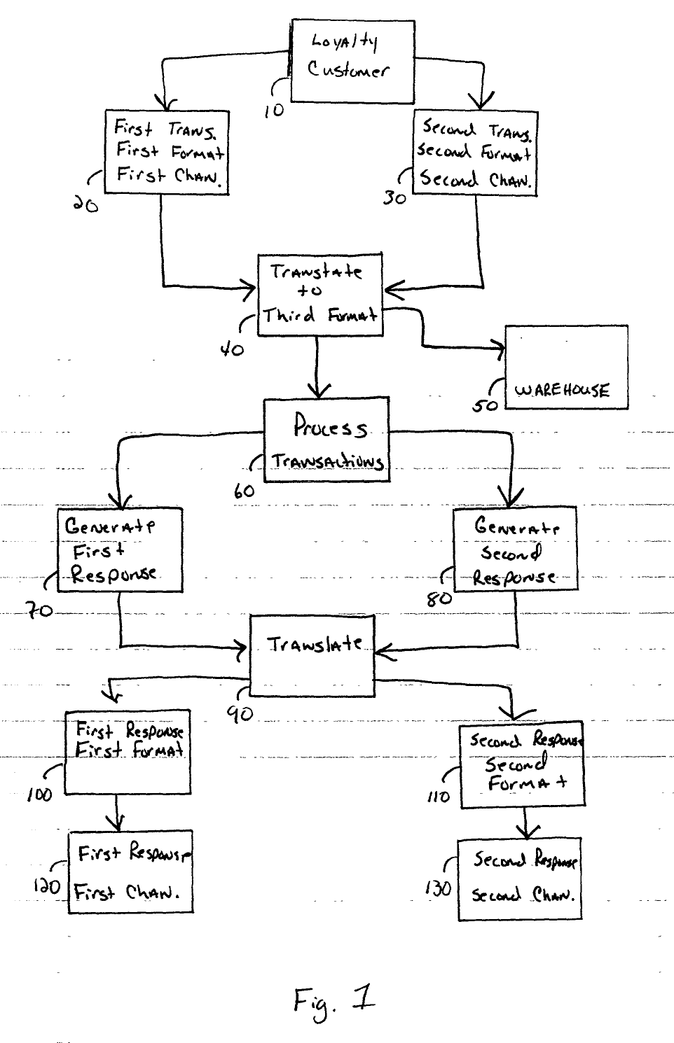

FIG. 1 illustrates a flow diagram of a method for tracking loyalty transactions. In FIG. 1, a single loyalty customer 10 may perform one or more transactions concurrently or simultaneously. For example, in step 20 a first transaction (e.g., a request for loyalty member information) may occur in a first format (e.g., HTML) over a first channel (e.g., the Internet). Independently, a second transaction (e.g., crediting loyalty points for an authorized purchase) occurs in a second format (e.g., POS data code format) over a second channel (e.g. POS device, credit card swipe machine).

By way of example only, consider a single customer approaching a sales person in a mall to buy some good or service using a credit card which is associated with a loyalty program. The sales person runs the credit card through a POS card reader, and the corresponding information is sent to the credit card issuer for verification. The purchase information is also sent to a loyalty program application for recording the transaction. Simultaneously, the card reader may provide a web browser interface which displays the customer's information. If the customer desires to see their loyalty point total, the browser transmits a “get-member-information” request to the loyalty program application via the Internet.

Further, the Internet request may be automatic such that it is the loyalty program application which, once contacted by the POS device for a customer transaction, locates and sends customer information (e.g. customer loyalty point totals) to a computing device of the sales person, a computing device of the customer, or even the POS device. Moreover, this response by the loyalty program application may be further automated such that a customer loyalty point total automatically prints on the customer's receipt. Additionally, a web page link may be printed or provided to the customer by the loyalty program application so that the customer may acquire additional information, or perhaps participate in, for example, a merchant driven survey to acquire additional loyalty points.

As is readily apparent, any number of channels may be used by a loyalty customer, and the above presented example is one of many possible customer transactions. For example, a loyalty customer may use a kiosk, such as an automated gas pump device, where the customer swipes a credit card to acquire gas, and the loyalty program application is notified and responds on the same channel with gift certificate redemption offers, or other offers. In this way, the customer communicates in real time with the loyalty program application, and the merchant has the opportunity to affect customer behavior before the completion of a customer transaction.

Prior to processing any transaction request, each transaction is translated into a third format in step 40. Logging information regarding each transaction also may be warehoused in step 50. Logging information may include, by way of example only, the type of transaction, date of transaction, channel of transaction, geographic location of transaction, dollar value of transaction, program owner identification, and others.

Transactions are processed in step 60, wherein a first response in step 70 and a second response in step 80 may be generated if the transactions were originally types of transactions which required responses to be generated. However, as one skilled in the art will appreciate all transactions may require a response, if only to acknowledge that a transaction has in fact been successfully received for processing. Responses are translated in step 90 to a first format in step 100 (e.g., HTML) and a second format in step 110 (e.g., POS data format) as appropriate. Once translated the first response is sent via the first channel in step 120 (e.g., Internet) and the second response is sent to a second channel in step 130 (e.g., POS device).

Although only a few examples are presented above, it is readily apparent that any number of loyalty based transactions occurring over single or disparate channels by single or multiple customers may occur, all of which fall within the scope of the present invention.

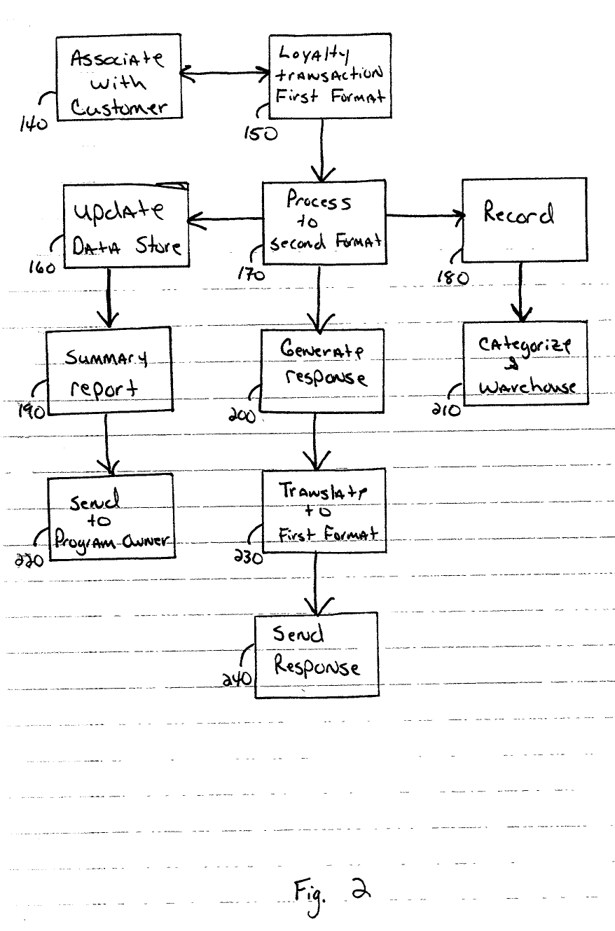

FIG. 2 illustrates a flow diagram of a method for processing a loyalty transaction. A loyalty transaction is received in a first format in step 150 and associated with a loyalty customer in step 140. Associating a loyalty transaction with a particular loyalty customer is well known to those skilled in the art. For example, a typical loyalty transaction includes some type of unique identification such as an account number, a social security number, and others. This unique information is acquired from a customer credit card, or provided by the customer. Furthermore, the information is easily mapped to a specific loyalty customer's electronic account by doing a simple data store search using the unique information as a key, correspondingly, electronic association of a transaction with a loyalty customer is readily apparent.

The transaction is then processed in a second format compatible with the loyalty program application in step 170 where the transaction may be recorded in step 180 and a loyalty program application data store updated in step 160. Further, a response to the transaction is generated in step 200, such as by way of example only, an opportunity for the customer to take a survey or buy an additional item within a specified time frame to receive additional gift certificates or loyalty points. Any response generated is then translated to the first format in step 230 and sent back to the customer in step 240. Although, as previously presented it may be that a response is sent over a different channel to the customer.

Independent of processing the transaction, information regarding the transaction may be trapped and recorded. For example, the transaction may be categorized and warehoused in step 210, so as to permit better data searching and data mining of the transactions occurring with the customers. Categorizing and warehousing loyalty transactions may permit business analysts and researchers to determine trends occurring within the transactions and assist them in developing more successful loyalty programs by using standard statistical analysis and other methods.

As one skilled in the art will appreciate, updating may occur in real time or in batch, correspondingly, updates may differ from warehousing since warehousing may occur with more regularity than updates. In situations where updates are not done in real time for performance reasons, what has been warehoused since the last update will eventually migrate to an editorial master data store on future batch updates.

Further, periodically information regarding the activity associated with the transactions may be summarized in an electronic report in step 190 and sent electronically to an owner of the loyalty program in step 220.

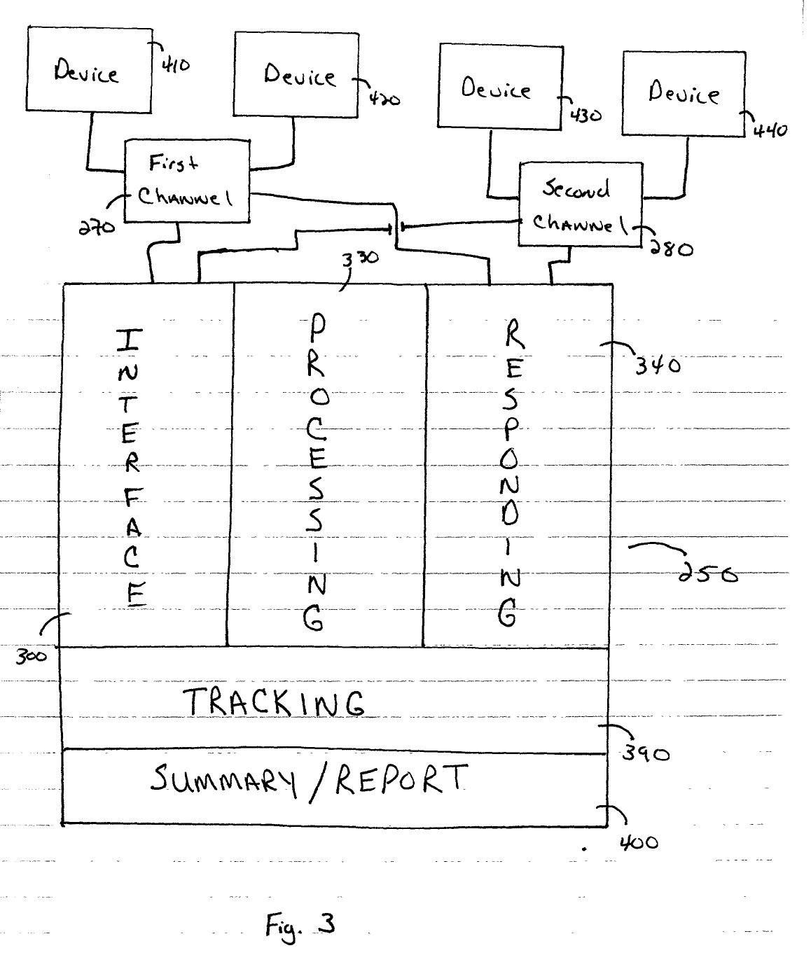

FIG. 3 illustrates a block diagram of a system for processing loyalty transactions. The system 250 of FIG. 3 includes an interface set of executable instructions 300 operable to translate a first transaction in a first format occurring over a first channel 270 to a processing format, and operable to translate a second transaction in a second format occurring over a second channel 280 to the processing format, and further a processing set of executable instructions 330 operable to process the first and second loyalty transactions in the processing format.

Initially, an interfacing set of executable instructions 300, such as by way of example only, a JavaBean application (e.g. API) residing on a loyalty server which is operable to detect a first loyalty transaction occurring over a first channel 270 selects an appropriate XSLT data formatting file for rendering data provided in a first format to a first loyalty transaction processing format. Likewise, the JavaBean application detects a second loyalty transaction occurring over a second channel 280 and selects a different XSLT data formatting file for rendering data provided in a second format to a second loyalty transaction processing format 320. Further, each channel may be used for communication with a variety of disparate devices 410-440.

In this manner, the system 250 is capable of processing two disparate transactions by normalizing each transaction format to a standard processing format which is recognizable by the processing set of executable instructions 330. Further, as one skilled in the art will readily appreciate the system 250 need not reside on a single computing device, but may be dispersed over multiple computing devices. Moreover, the interface set of executable instructions 300 and the processing set of executable instructions 330 need not be centralized on a single computing device.

For example, and by way of example only, consider a POS first transaction where a customer using a credit card to purchase a good or a service sends the transaction directly to a loyalty server (e.g. system 250) via a direct phone connection. Once connected with the loyalty server a JavaBean application determines the transaction is occurring with a POS device and uses an appropriate XSLT application data file to translate the information being received from a first POS data format to a loyalty program processing format. As previously presented the POS data format, will typically be provided in a raw XML format and the connection to the loyalty server will indicate that a POS device or channel is making the connection. Accordingly, the JavaBean application may readily select an appropriate XSLT application data file to render the raw XML data to the processing format necessary for processing by the loyalty program application (e.g. processing set of executable instructions 330).

Independently, or simultaneously, a second transaction may be received from a web connection requesting the customer's loyalty point total, the JavaBean application detects this request as a web request and selects a different XSLT application data file which translates the transaction into the processing format.

The individual transactions may then be processed by a processing set of executable instructions 330. Processing may include, by way of example only, updating point totals associated with a customer account, providing redemption authorization to acquire something of value by debiting existing loyalty points associated with a customer account, and others. One skilled in the art will readily appreciate that loyalty based software programs are used extensively and processing may be readily acquired with off-the-shelf software available in the industry.

Moreover, during or at the conclusion of processing a transaction, a response may be required by a responding set of executable instructions. Again, responding to a loyalty transaction is well known to those skilled in the art and is readily available with off-the-shelf software packages. Some responses which may occur include, by way of example only, acknowledgment that a transaction was received and processed, information requested as a result of a transaction, and others.

While processing and responding takes place, a tracking set of executable instructions 390 may monitor the transactions for purposes of recording the actions being taken by the processing 330 and responding 340 set of executable instructions. Some information which may be tracked, includes by way of example only, transaction type, transaction location, transaction response time, demographics (e.g. age, gender, income level, and others) associated with the customer initiating the transaction, and others.

Furthermore, a summary and/or reporting set of executable instructions 400 may be used to mine the information recorded by the tracking set of executable instructions 390 and produce individualized reports. Custom report generation is well known in the art and readily available as off-the-shelf software packages. These report generators provide interfaces to mine data stores and produce custom reports or summaries.

Once a response is generated, the data associated with the response will again be translated into a format that is appropriate for the channel over which the response will be sent. Translation, by way of example only, may occur by a JavaBean application selecting an appropriate XSLT data format file, and the response data (e.g. in XML format) is rendered to the appropriate channel format. A first response 350 may be sent over the first channel 270 and a second response 380 may sent over a second channel 280.

As one skilled in the art will readily appreciate, a variety of configurations and processing sequences may occur without detracting from the present invention. For example the loyalty program may initiate a second transaction with a loyalty customer over a disparate channel, such as when a customer initiated phone transaction occurs, the loyalty program in response may initiate a web transaction over the Internet using a web browser, or may send a transaction in an electronic email to the customer.

The foregoing description of the preferred embodiment of the invention has been presented for purposes of illustration and description. It is not intended to be exhaustive nor to limit the invention to the precise form disclosed. Many alternatives, modifications, and variations will be apparent to those skilled in the art in light of the above teaching. For example, although XML data format was used to describe an intermediate data format for processing loyalty transactions, any consistent data format will suffice and would be readily apparent to one skilled in the art. Accordingly, this invention is intended to embrace all alternatives, modifications, and variations that fall within the spirit and broad scope of the attached claims.

What is claimed is:

1. A method of tracking loyalty transactions over disparate channels, having executable instructions comprising:
receiving a first loyalty transaction in a first format over a first channel;
receiving a second loyalty transaction in a second format over a second channel; and
translating the first loyalty and the second loyalty transactions to a third format for processing.

2. The method of claim 1, further comprising:
generating a first response to the first loyalty transaction in a third format;
translating the first response to the first format; and
sending the first response in the first format over the first channel.

3. The method of claim 2, further comprising:
generating a second response to the second loyalty transaction in a third format;
translating the second response to the second format; and
sending the second response in the second format over the second channel.

4. The method of claim 1, further comprising:
warehousing the transactions in a data store.

5. The method of claim 1, wherein the channels are at least one of a telephone channel, a point of sale channel, and Internet channel, a direct connection channel, a web television channel, an automated teller machine channel, a wireless channel, a kiosk channel, and an interactive television channel.

6. The method of claim 1, wherein the transactions are associated with a single loyalty customer.

7. The method of claim 1, wherein the firs and second formats are compatible with extended markup language.

8. A method of processing a loyalty transaction having executable instructions comprising:
translating a loyalty transaction from a first format to a second format;
processing the loyalty transaction in the second format;
translating a response to the loyalty format to the first format; and transaction.

9. The method of claim 8, further comprising:
recording the loyalty transaction.

10. The method of claim 9, further comprising:
categorizing and warehousing the loyalty transaction.

11. The method of claim 8, further comprising:
updating a data store associated with the loyalty transaction.

12. The method of claim 8, further comprising:
receiving the loyalty transaction from one or more channels.

13. The method of claim 12, further comprising:
associating the loyalty transaction with a loyalty customer.

14. The method of claim 13, further comprising:
including the loyalty transaction in a summary report associated with a loyalty program.

15. The method of claim 14, further comprising:
sending the summary report to an electronic account associated with an owner of the loyalty program.

16. A system for processing loyalty transactions over disparate channels, comprising:
an interface set of executable instructions operable to translate a first loyalty transaction having a first format and occurring over a first channel and operable to translate a second loyalty transaction having a second format and occurring over a second channel to a processing format; and
a processing set of executable instructions operable to process the first and second loyalty transactions in the processing format.

17. The system of claim 16, further comprising:
a responding set of executable instructions operable to send one or more responses received from the processing set of executable instructions and translated by the interface set of executable instructions over the first and second channels.

18. The system of claim 16, further comprising:
a tracking set of executable instructions operable to record a history associated with the loyalty transactions.

19. The system of claim 18, further comprising:
a summary set of executable instructions operable to report the history to an owner associated with the loyalty transactions.

20. The system of claim 16, wherein the first and second formats are operable to be interfaced with extensible markup language.
